(19) United States
(12) Patent Application Publication
(10) Pub. No.: US 2007/0273626 A1
(43) Pub. Date: Nov. 29, 2007

(54) System for pixel defect masking and control thereof

(75) Inventors: Louis Joseph Kerofsky, Camas, WA (US); Dean Messing, Camas, WA (US)

Correspondence Address: KEVIN L. RUSSELL;CHERNOFF, VILHAUER, MCCLUNG & STENZEL LLP, 1600 ODSTOWER, 601 SW SECOND AVENUE, PORTLAND, OR, 97204, US

(73) Assignee: Sharp Laboratories of America, Inc.

(21) Appl. No.: 11/418,333

(22) Filed: May 4, 2006

(51) Int. Cl. G09G 3/36

(52) U.S. Cl. 345/87

(57) ABSTRACT

A technique for the modification of sub-pixels to hide defects for defective sub-pixels.

### CROSS-REFERENCE TO RELATED APPLICATIONS

Not applicable.

### BACKGROUND OF THE INVENTION

The present invention relates to techniques for the modification of sub-pixels.

The most commonly used method for displaying images on a color mosaic display is to pre-filter and re-sample the pixels of the image to the display. In the process, the R, G, B values of selected color pixels are mapped to the separate R, G, B elements of each display pixel. These R, G, B elements of a display pixel are sometimes also referred to as sub-pixels. Because the display device does not typically allow overlapping color elements, the sub-pixels can only take on one of the three R, G, or B colors. The color's amplitude, however, can be varied throughout the entire grey scale range (e.g., 0-255). Accordingly, a rendering that maps image pixels to display sub-pixels is performed.

Referring to FIG. 1A, there exists a number of variety of different sub-pixel configurations. In general, the sub-pixel combinations can be grouped as RGB striped, RGBW striped, multi-primary, or repeating two-dimensional patterns. For each sub-pixel configuration the associated “display” is shown as a 4×4 array of sub-pixels immediately below in FIG. 1B.

Active matrix liquid crystal display panels achieve their images, in part, because of the individual transistor and capacitor placed at each sub-pixel. The transistor and capacitor latch the data to the pixel electrode that controls the amount of backlight that passes through a given sub-pixel. Occasionally, one or more transistors will malfunction, resulting in one or more defective sub-pixels. There are at least two ways a transistor can fail. One failure mode, a permanently open circuited transistor, results in an always-off or always-on sub-pixel. Another mode of failure, a permanently short circuited transistor, results in a sub-pixel whose brightness value varies over time but in a way not directly tied to the image data to which it should be associated. Also, the sub-pixel may be stuck at an intermediate constant value or may vary in some manner based upon the state of the display, such as the data currently in the frame buffer.

Always-on sub-pixels appear as randomly placed red, blue, and/or green elements on an all-black background. Always-off sub-pixels appear as black or colored dots on all-white or colored backgrounds. The probability of always-on and always-off sub-pixel defects depends on the LCD process. In the most general case, a defective sub-pixel is a sub-pixel whose output light value can not be controlled.

By way of example, the data in the frame buffer may vary the pixel value when the row driver connection to the defective sub-pixel is damaged such that the sub-pixel is always “enabled.” In this case, as the scan lines are written to the column drivers, the signal to the faulty sub-pixels will fluctuate according to the instantaneous values in the column buffer for that column. The slow temporal response will tend to make the output of the defective sub-pixel a constant for the duration of (at least) a frame period. That constant is approximately given by

$$f ( {\sum }_{i = 0}^{N - 1} {p}_{i} / N )$$

where pᵢ is the signal input to the i^{th} sub-pixel in the column containing the defective sub-pixel, N is the number of display lines, and f accounts for the temporal response of the sub-pixel and the transfer function between signal and light output. This value will generally be different from the desired output were the sub-pixel operating properly.

Referring to FIG. 2, an example of five 4×4 displays is illustrated with the always-off defective sub-pixels. It is shown that the defective sub-pixels are illustrated as black regions. In some cases, such as the right-hand configuration shown in FIG. 2, a white sub-pixel may be used to enhance the luminance of the display, without altering the color gamut. Referring to FIGS. 3A and 3B, the white sub-pixel may be used to correct for defects. As illustrated, the de-saturated portion of the pixel in FIG. 3A is transferred to the white sub-pixel in FIG. 3B. However, the same white sub-pixel, along with the additional “headroom” in the primary color pixels can be used to hide some defects in a given RGBW quadruple.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1A illustrates some sub-pixel configurations.

FIG. 1B illustrates 4×4 portions of displays.

FIGS. 2A and 2B illustrate five 4×4 displays with sub-pixel configurations with defective sub-pixels.

FIG. 3A illustrates a RGB pixel.

FIG. 3B illustrates the pixel of FIG. 3A incorporating a white sub-pixel.

FIG. 4 illustrates a scan line of incoming image pixels.

FIG. 5 illustrates the formation of the perceptual error function C.

FIG. 6 illustrates constraints for 1-dimensional striped pattern.

FIG. 7 illustrates general vector valued filtering of a vector valued signal

FIG. 8 illustrates constraints for a 2-dimensional pattern.

FIG. 9 illustrates a pentile pattern.

FIG. 10 illustrates two-dimensional filters.

FIG. 11 illustrates linear shift-varying convolution.

FIG. 12 illustrates shift-invariant optimal rendering filters.

FIG. 13 illustrates collection of shift-varying filter kernels.

FIG. 14 illustrates luminance and chrominance CSFs.

FIG. 15 illustrates the effect of shift varying rendering filters.

FIG. 16 illustrates a defect masking system.

FIG. 17 illustrates a defect masking system with updates.

FIG. 18 illustrates a red always off test pattern.

FIG. 19 illustrates a green always off test pattern.

FIG. 20 illustrates blue always off test pattern.

FIG. 21 illustrates an always on test pattern.

FIG. 22 illustrates a test pattern seen on a defective display.

FIG. 23 illustrates a test image with one known defect and a second unknown defect.

FIG. 24 illustrates a test pattern following addition of a second defect.

FIG. 25 illustrates always on test image on a display with two defects.

FIG. 26 illustrates an always on test image with known green and unknown red defects.

FIG. 27 illustrates an always on test image with two defects known to the system.

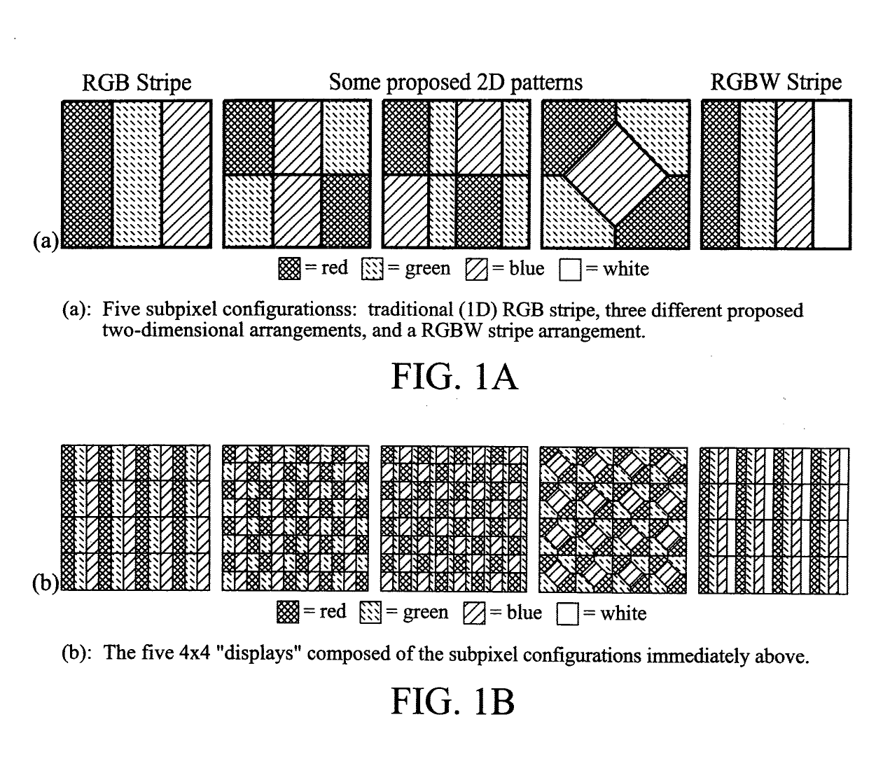

### DETAILED DESCRIPTION OF PREFERRED EMBODIMENT

Embodiments may be described with reference to “RGB” images or domains, or “additive color domains”, or “additive color images.” These terms refer to any form of multiple component image domain with integrated luminance and chrominance information, including, but not limited to, RGB domains. Embodiments may also be described with reference to “YCbCr” images or domains, “opponent color” domains, images or channels, or “color difference” domains or images. These terms refer to any form of multiple component image domain with channels which comprise distinct luminance channels and chrominance channels including, but not limited to, YCbCr, LAB, YUV, and YIQ domains. Color domains where one or more channels have an enhanced luminance component with respect to the other channels may likewise be used. One potential measure of such enhancements is if a channel has >60%, >70%, >80%, >90%, or >95% of the luminance. In addition, the enhanced luminance color domain may be as a result of implicit processing in another color domain as opposed to a traditional color transformation from one color space to another.

The system is generally described with respect to non-overlapping pixels, or otherwise spatially discrete color sub-pixels (e.g., color mosaic or matrix displays). However, the embodiments described herein may likewise be used with colors that are overlapping to a greater or lesser degree. Moreover, the images may be displayed using different sizes of pixels and/or any different colors of sub-pixels. In addition, while some of the preferred embodiments are described with respect to rectangular pixels and sub-pixels, other shapes of pixels and sub-pixels may likewise be used. Also, any particular pixel may be formed by a plurality of sub-pixels in any arrangement, some of which may be duplicated. Moreover, the display may include any structure of different colored sub-regions.

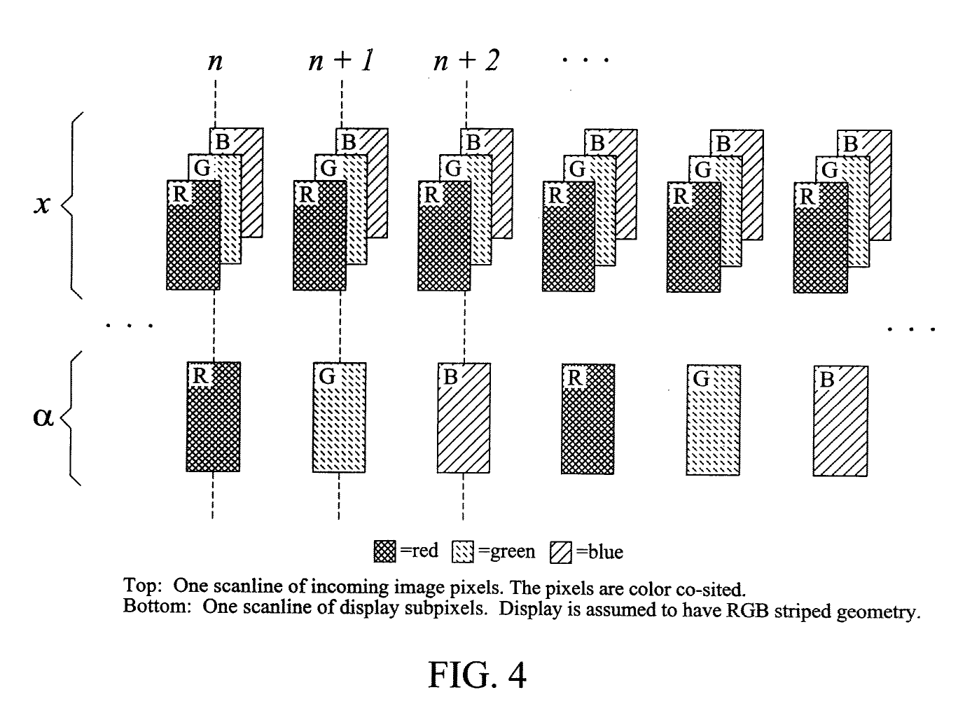

The preferred technique for defect hiding is based upon a constrained optimal rendering framework described below. An unconstrained technique suitable for optimal rendering filter design on a striped display is first discussed followed by a constrained technique for optimal rendering filter design on arbitrary display geometries. An unconstrained optimization may be based upon a desire to minimize a perceptually relevant error, [symbol] (α), between a scan line of color co-sited image samples, x, sampled at the sub-pixel locations of the target display, and the corresponding flat panel display scan line of R, G, and B sub-pixels, α. FIG. 4 depicts x and α where the sub-pixel location along the scan line is indexed by n.

Each xₙ is a vector valued quantity that represents the RGB value of the incoming image pixel at position n. Scalar valued display sub-pixels are denoted by αₙ. The RGB striped display geometry dictates that αₙ alternatively represents a red, green, or blue sub-pixel as a function of n mod 3.

The error [symbol] (α) to be minimized with respect to α is constructed by first forming the spatial error signal:
Eₙ=Mₙαₙ−Cxₙ
where C is a 3×3 color transformation matrix that maps xₙ into a perceptually relevant opponent color space, and where Mₙ=3C_{n mod 3}, Cₙ being the n^{th} column of C. The error signal E is then transformed to the Fourier domain and the opponent color components of the transformed signal are perceptually weighted. Finally [symbol] (α) is formed as the sum of the 1₂ norms of the weighted Fourier color components. Thus [symbol] is a weighted quadratic function of the Fourier transform of {Eₙ} and hence possesses a unique minimum.

The optimal solution, α, satisfies ∇ [symbol] (α)=0. That is, α is the scan line of sub-pixel values that minimizes [symbol] (α). The quadratic form of [symbol] implies that the gradient may be written as an affine system ∇ [symbol] =Aα−r. Furthermore, the structure of A allows one to extract, from the solution to this equation, rendering filter kernels which, when convolved in the proper way with the incoming scan line, yields α.

It may be observed that this rendering filter design is an unconstrained optimization procedure. No explicit mathematical constraints were imposed during the optimization technique described above. There are, to be sure, implicit constraints in the formation of [symbol] , namely those inherent in the definition of α. The color of a particular αₙ may be one component color of the input color space, typically not a vector combination of primaries. Furthermore, the sequence of colors that αₙ encodes is determined implicitly by Mₙ. In other words, the sub-pixel geometry of the RGB striped display is implicitly assumed by a color vector, Mₙαₙ, that varies cyclically (modulo 3) with the position of the rendered sub-pixel.

One may further observe that a different sub-pixel geometry, perhaps containing additional primaries, may require a re-definition of Eₙ as well as a re-working of the solution to ∇ [symbol] (α)=0. This framework may be extended to general two-dimensional multi-primary sub-pixel geometries by recasting the problem as a constrained optimization. Doing this de-couples the definition of the sub-pixel geometry could be de-coupled from the formation of [symbol] .

Using constrained optimization images may be optimally rendered on a wide variety of regularly tessellated color matrix displays. De-coupling the sub-pixel geometry from the definition of [symbol] may be done by formulating a constrained optimization of the form:

$$\begin{matrix}∇ C - ( \tilde{x} ) + {\sum }_{i} {λ}_{i} ∇ {G}_{i} ( \tilde{x} ) = 0 & ( 1 ) \\ ∀ i {G}_{i} ( \tilde{x} ) = 0 & ( 2 )\end{matrix}$$

where the Gᵢ are constraint functions determined by the sub-pixel geometry, the λᵢ are associated Lagrange multipliers, and where [symbol] is a weighted quadratic function of the two-dimensional transform {Eₘₙ} similar to that described above. Eₘₙ may be defined as
Eₘₙ=C(\tilde{x}ₘₙ−xₘₙ)
where C is the color transformation matrix previously described, xₘₙ is the sampled scene, and \tilde{x}ₘₙ is an unconstrained full-color display sample at the sub-pixel indexed by (m,n). Before the constraints are imposed, an assumption is that each of the ‘sub-pixels’ of the target display have full color capability. To simplify the analysis one may also assume that the scene is sampled on the same lattice as \tilde{x}.

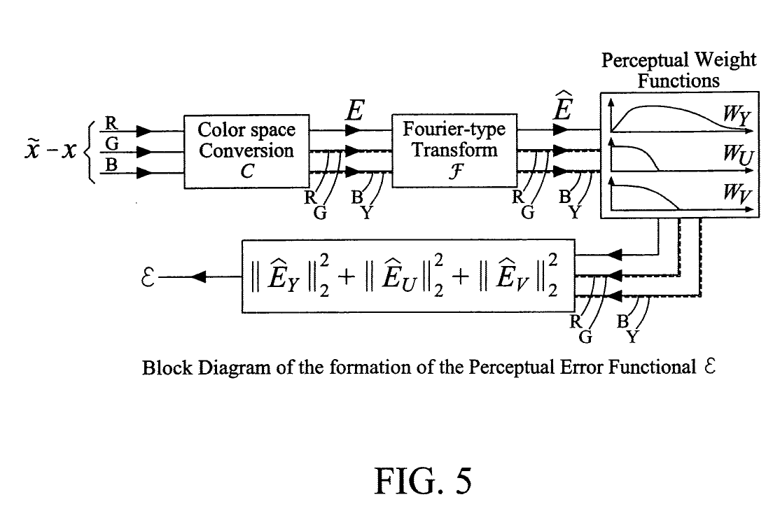

The steps to the formation of the perceptual error function, [symbol] (\tilde{x}), are shown in FIG. 5 where YUV opponent color space is used merely as an example. The actual color transformation, C, depends on the primaries of the display to be visually optimized. The perceptual weight functions used in the formation of [symbol] are preferably models of the luminance and chrominance spatial contrast sensitivity functions of the human visual systems.

Before constraints are imposed one may assume that “sub-pixels” of the target display have full-color capability. The constraint functions, Gᵢ, control the behavior of each sub-pixel in the display. For example, to make a green sub-pixel at display lattice location (m,n), one defines two linear constraint functions:
Gᵢ_{₁}(\tilde{x})=\tilde{x}ₘₙ⁰,Gᵢ_{₂}(\tilde{x})=\tilde{x}ₘₙ² (3)
where \tilde{x}ₘₙ^{c} is the c^{th} color component of \tilde{x}ₘₙ. Equation 3 states that the 0^{th} (red) and 2^{nd} (blue) components of \tilde{x}ₘₙ will be forced to zero when equation 2 is applied. In other words, starting with a sub-pixel having a potential of red, green, and blue colors the constraints limit the sub-pixel to a single color component, namely, green.

The quadratic form of [symbol] implies that the first term in equation 1 is linear: ∇ [symbol] =A\tilde{x}−r. Thus equations 1 and 2 may take the form

$$[ {{AG}^{′} ( \tilde{x} )}^{T} ] [ \begin{matrix}\tilde{x} \\ Λ\end{matrix} ] = r , \\ G ( \tilde{x} ) = 0 ( \tilde{x} ) \qquad ( 4 )$$

where G′ is the (Jacobean) derivative of G, and thus G′^{T} has ∇Gᵢ as its i^{th} column. In general, this system is non-linear due to G and G′. But constraint functions of the type used to define sub-pixel geometries are linear so G(\tilde{x}) reduces to G\tilde{x} and G′(\tilde{x}) is independent of \tilde{x}. Therefore equation 4 can be rewritten as an augmented linear system as follows:

$$[ \begin{matrix}A & {G}^{′ T} \\ G & 0\end{matrix} ] [ \begin{matrix}\tilde{x} \\ Λ\end{matrix} ] = [ \begin{matrix}r \\ 0\end{matrix} ] \qquad ( 5 )$$

The operators A, G′ and G depend only on the display and not on the scene data. Only r is a function of the scene data. Furthermore, the simplicity of the constraint functions makes G′ and G sparse, reducing the complexity of numerical solution. Also, as in the unconstrained case, the structure of A allows the extraction of convolutional, shift-invariant, rendering filters which operate on the scene and yield the optimal \tilde{x}. This is a consequence of the periodic nature of the applied constraints—they are the same from macro-pixel to macro-pixel.

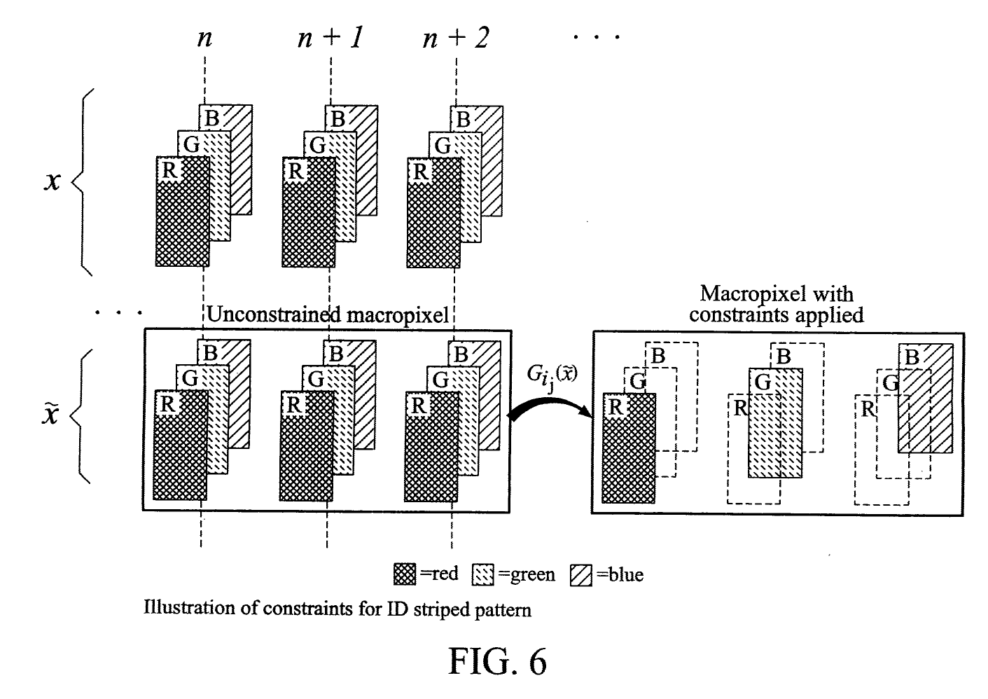

The constraints applied to one dimensional striped geometry is illustrated in FIG. 6. FIG. 6 illustrates part of one scan line of the sampled scene, x, and, immediately below, the corresponding full color display sub-pixels, \tilde{x}. Sub-pixel location along the scan line is indexed by n. Before constraints are imposed there are a total of nine degrees of freedom, namely, each of the colors at each position of the unconstrained macro-pixel. When no constraints are imposed the optimal solution occurs when the full color display sub-pixels are a straight copy of the scene values since the resulting error would be zero.

In a panel the color range of each sub-pixel is limited to its particular color hue. One may insure this condition by imposing two constraints at each of the three sub-pixel sites that must be zero in order for the macro-pixel to behave properly. The zero valued sub-pixels are represented by the hollow rectangles. The six constraint functions for this macro-pixel are
Gᵢ_{₁}(\tilde{x})=\tilde{x}ₙ¹
Gᵢ_{₂}(\tilde{x})=\tilde{x}ₙ²
Gᵢ_{₃}(\tilde{x})=\tilde{x}ₙ₊₁⁰
Gᵢ_{₄}(\tilde{x})=\tilde{x}ₙ₊₁²
Gᵢ_{₅}(\tilde{x})=\tilde{x}ₙ₊₂⁰
Gᵢ_{₆}(\tilde{x})=\tilde{x}ₙ₊₂¹
This leaves three degrees of freedom—the three actual sub-pixel intensities to be adjusted by the optimization procedure. When the optimization is performed on an interval of constrained macro-pixels within a scan line, the system of equation 5 can be solved and shift-invariant rendering filters extracted.

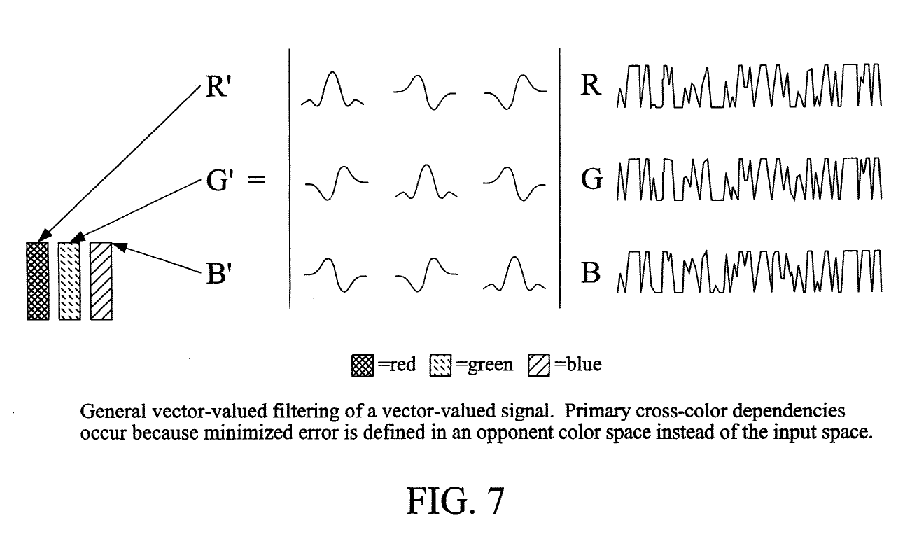

The extracted filter kernels for the previous example form an array, or matrix, of one dimensional scalar valued resampling filters, as illustrated in FIG. 7. The matrix nature of the rendering filter is due to the error measure having been defined in a color space different from the input and output color space. The value of each output sub-pixel will, in general, be a function of all input color components. FIG. 7 suggests how the filter operates on the scene data. To the right of the matrix are the three RGB color components of the incoming scene. The filters within the matrix are combined with scene data in a manner suggestive of matrix multiplication except multiplication is replaced by convolution. So, for example, the filters in the first row are convolved with the incoming color signals and the intermediate signals are added to form the red component (labeled R′ in the figure) sent to the display.

Equation 6 expresses FIG. 7 in a more formal manner. The subscripts of the entries of the matrix filter indicate the input signal on the left of the arrow and the output signal on the right of the arrow. For example h_{g→r} is the filter whose input is the green component (x^{g}) of the scene on the scan line being processed, and whose output is the red (\tilde{x}^{r}) display signal.

$$[ \begin{matrix}{\tilde{x}}^{r} \\ {\tilde{x}}^{g} \\ {\tilde{x}}^{b}\end{matrix} ] = [ \begin{matrix}{h}_{r \to r} & {h}_{g \to r} & {h}_{b \to r} \\ {h}_{r \to g} & {h}_{g \to g} & {h}_{b \to g} \\ {h}_{r \to b} & {h}_{g \to b} & {h}_{b \to b}\end{matrix} ] [ \begin{matrix}{x}^{r} \\ {x}^{g} \\ {x}^{b}\end{matrix} ] \qquad ( 6 )$$

The matrix multiplication may be interpreted as substituting for the multiplications of the inner products the convolution (·) operator for the usual scalar multiplications. Hence, for example,
\tilde{x}^{g}=(h_{r→g}·x^{r})+(h_{g→g}·x^{g})+(h_{b→g}·x^{b}).
One may observe from equation 6 that the sum of three individual convolutions are used to compute each component of the vector valued (r, g, b) output signal \tilde{x} from the vector valued (r, g, b) input signal x.

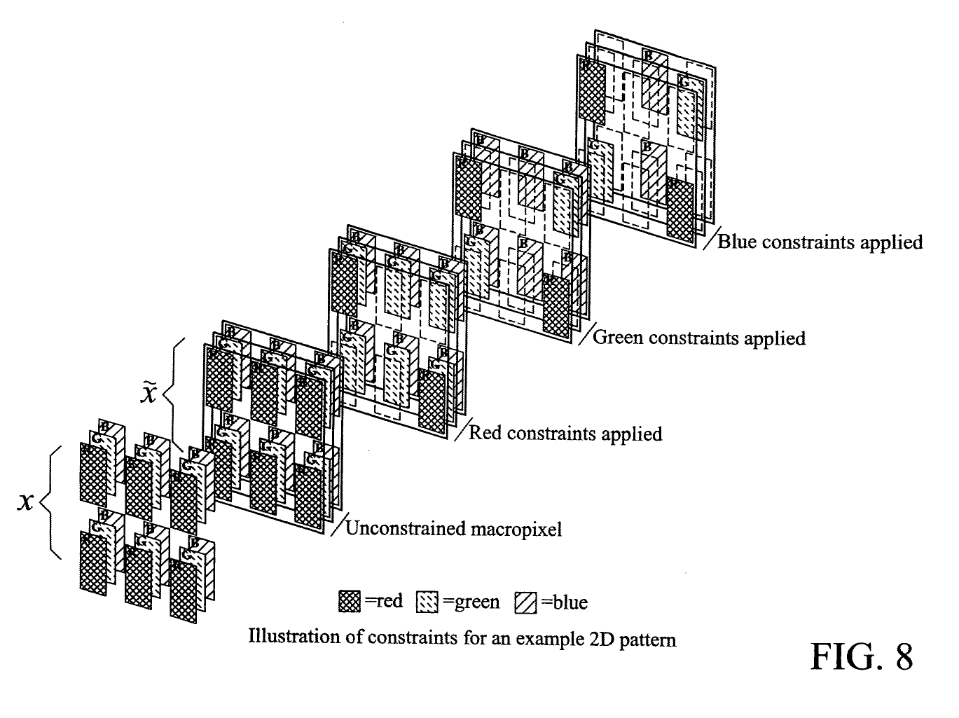

The constraints applied to an example two dimensional geometry is illustrated in FIG. 8. The target macro-pixel contains two independent red sub-pixels, two independent green sub-pixels, and a single blue sub-pixel made from two blue segments that are electrically tied together, as illustrated in FIG. 8. On the left are samples of the full color co-sited scene, x. Next is the corresponding macro-pixel from the unconstrained display, \tilde{x}, with sub-pixel \tilde{x}_{m,n}. in the upper left corner of the macro-pixel. Constraints are applied in stages for the purpose of illustration. First, four red constraints are applied:
Gᵢ_{₁}(\tilde{x})=\tilde{x}_{m,n+1}⁰
Gᵢ_{₂}(\tilde{x})=\tilde{x}_{m,n+2}⁰
Gᵢ_{₃}(\tilde{x})=\tilde{x}_{m+1,n}⁰
Gᵢ_{₄}(\tilde{x})=\tilde{x}_{m+1,n+1}⁰
Next, four green constraints, Gᵢ_{₅}, . . . , Gᵢ_{₈}, are applied in a like manner, then four blue constraints, Gᵢ_{₉}, . . . , Gᵢ_{₁₂}. A final blue constraint, Gᵢ_{₁₃}(\tilde{x})=\tilde{x}_{m,n+1}²−\tilde{x}_{m+1,n+1}², is applied to force the remaining blue elements of the macro-pixel to function as a single sub-pixel. Prior to applying constraints, there are 18 degrees of freedom. Applying the 13 constraints results in a macro-pixel with 5 degrees of freedom that the technique can adjust to minimize perceptual error.

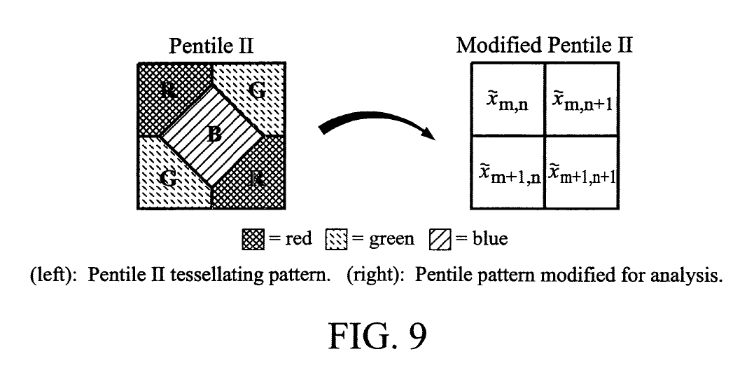

The constraints applied to another two dimensional geometry is illustrated in FIG. 9. The sub-pixels do not lie on a rectangular lattice so to facilitate the setup one may first modify the macro-pixel pattern to that shown on the right in FIG. 9. The grey patches represent unconstrained sub-pixel positions. The central blue sub-pixel has been removed and its contribution is distributed equally among the four patches via constrains.

Seven constraints on the \tilde{x}_{m,n} yield the desired macro-pixel pattern. The last three constraints force the four blue elements to act as a single blue sub-pixel within the macro-pixel.
Gᵢ_{₁}(\tilde{x})=\tilde{x}_{m,n}¹
Gᵢ_{₂}(\tilde{x})=\tilde{x}_{m,n+1}⁰
Gᵢ_{₃}(\tilde{x})=\tilde{x}_{m+1,n}⁰
Gᵢ_{₄}(\tilde{x})=\tilde{x}_{m+1,n+1}¹
Gᵢ_{₅}(\tilde{x})=\tilde{x}_{m,n}²−\tilde{x}_{m,n+1}²
Gᵢ_{₆}(\tilde{x})=\tilde{x}_{m,n}²−\tilde{x}_{m+1,n}²
Gᵢ_{₇}(\tilde{x})=\tilde{x}_{m,n}²−\tilde{x}_{m+1,n+1}² (7)

This has five degrees of freedom, i.e., five independently adjustable sub-pixel values, remain after applying these constraints. The value of each sub-pixel is again determined by all three input color components, so that a total of 15 filter kernels will be extracted from the solution of equation 5.

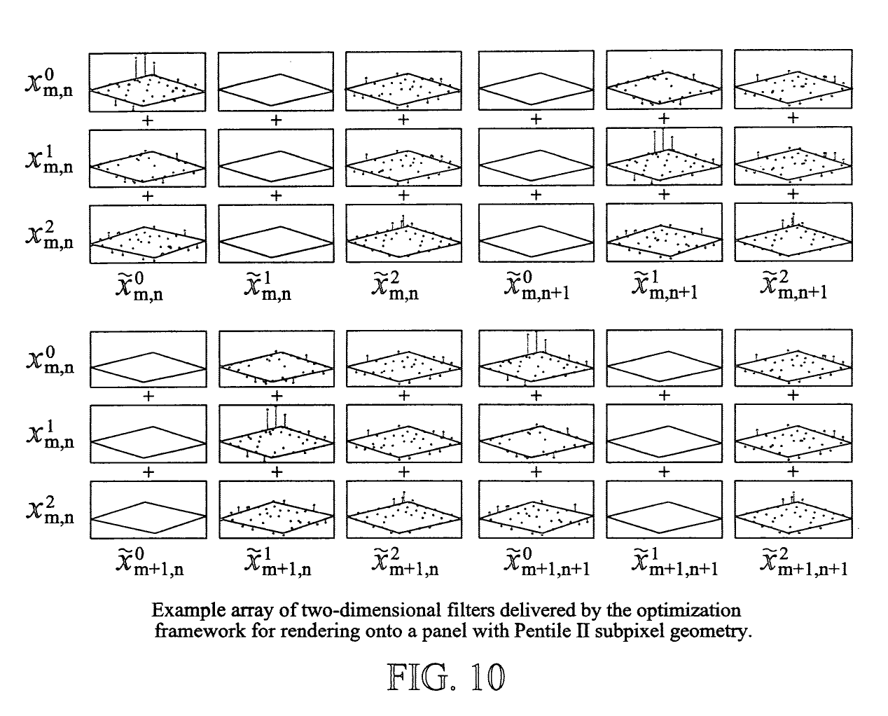

The matrix of the filters for this geometry are shown in FIG. 10. For this example, there is shown the complete array of 36 two dimensional filters, including the 12 zero filters and the duplicate blue output filters. They are grouped into 4 sub-arrays of nine filters. Each sub-array corresponds to the collection of filters that will handle one (RGB) sub-pixel of the pattern. For example, the filter in the second row of the first column of the upper left sub-array determines the green input channel's contribution to the upper left red sub-pixel. It may be observed that all filters in, for example, the second column of this sub-array vanish. This corresponds to the fact that the green sub-pixel in the upper left position is constrained to be zero. It is also observed that the third (last) column of filters of each sub-array are the same since all blue sub-pixels are constrained to be equal. The number of distinct filters in the entire matrix is 15 which corresponds to the five available degrees of freedom and the three dimensional input color space.

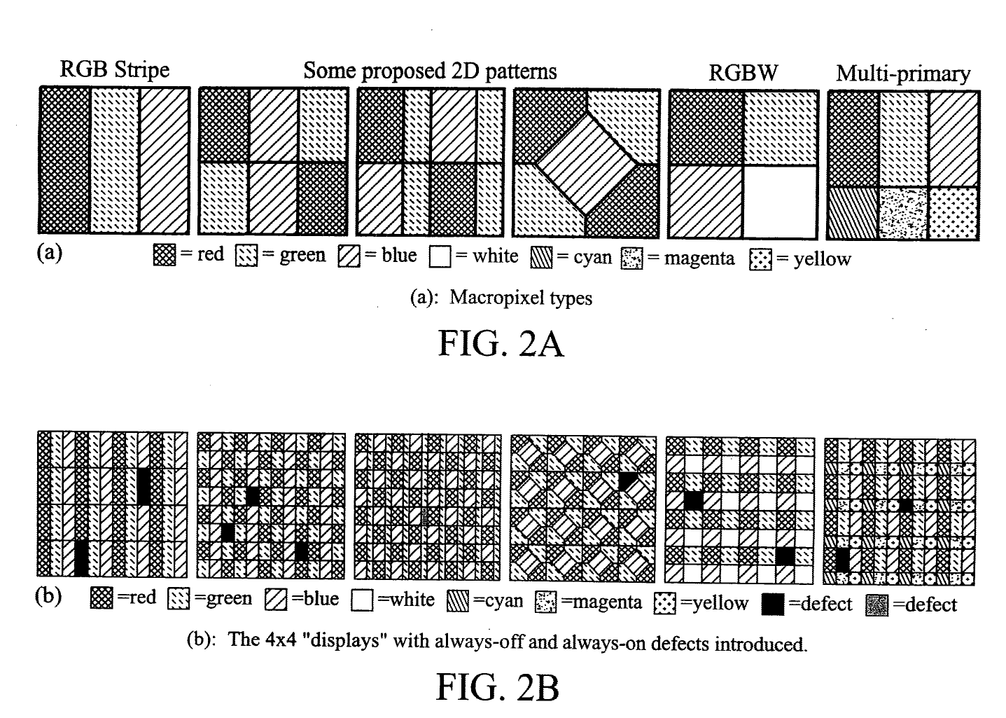

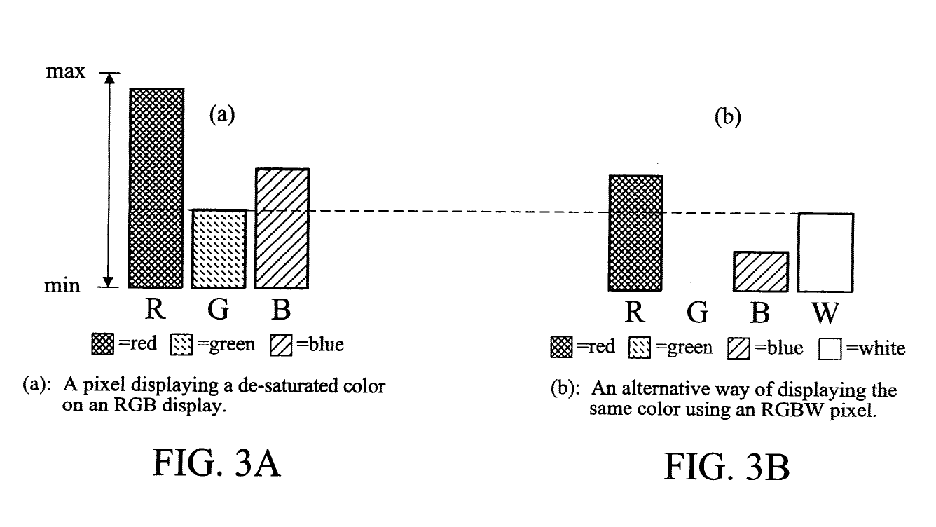

This general constrained optimization framework may be used to mask defective sub-pixels in a visually optimal manner. There are several types of defects, as previously noted. Examples of some potential geometries are illustrated in FIG. 2A and the corresponding 4×4 display in FIG. 2B. Such defective sub-pixels may result from defective temporal gray level modulation circuitry in a plasma display or a manufacturing flaw introduced into the diode substrate of an element in an OLED panel or the TFT of a LCD panel.

The general framework provides that the sub-pixel defects can be incorporated into the framework by the addition of defect constraints similar in form to those that define the geometry itself. For example, the three always-off defects in the 2^{nd} panel from the left in FIG. 2A can be represented by three constraint functions listed in raster scan order,
Gᵢ_{₁}(\tilde{x})=\tilde{x}_{3,4}²
Gᵢ_{₂}(\tilde{x})=\tilde{x}_{5,2}⁰
Gᵢ_{₃}(\tilde{x})=\tilde{x}_{6,8}¹
in addition to the geometry constraints already discussed. The subscripts on \tilde{x} are the (row, column) coordinates of the defect relative to an origin in the upper left corner. Similarly, the green always-on defect in the third panel from the left can be described by an affine constraint function,
Gᵢ_{₁}(\tilde{x})=1\tilde{−}x_{4,7}¹,
where the intensity range of a sub-pixel is assumed to be [0.1].

The system of rendering filters that result are now shift varying, in contrast to those used for defect free rendering. The convolution of a signal with a FIR filter is usually represented algebraically by an expression like

$$\tilde{x} ( n ) = {\sum }_{k = {N}_{1}}^{{N}_{2}} h ( k ) x ( n - k )$$

$$\tilde{x} ( n ) = {\sum }_{k = n - {N}_{2}}^{n - {N}_{1}} h ( n - k ) x ( k )$$

where N₁≦N₂ are integers, x and \tilde{x} are, respectively, the input and output signals, and h is the filter kernel of length N₂−N₁+1 with discrete support on the set {N₁, N+1, . . . , N₂}.

The two summations are equivalent but the second one is suggestive of the usual graphical interpretation of convolution as a fixed input signal, x(k), over which slides (from left to right) a reversed, shift-invariant, filter kernel, h(n−k). At each potion of the kernel, the filter coefficients are multiplied by the signal and the products are added to give the output value, \tilde{x}(n).

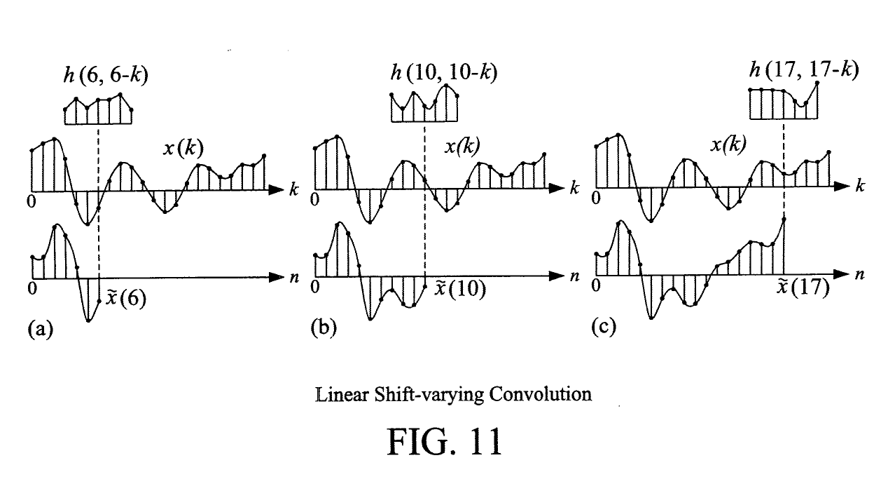

A shift-varying filter is one whose kernel changes as it shifts along the input data, as illustrated in FIG. 11. Such filters are not only a function of sample index but of shift position. That is they are a function of two independent variables, formally denoted by h(n,k). From FIG. 11, it may be observed that the second variable indexes the shift position and the first selects the particular filter kernel in the family of kernels h(−,k).

An outcome of introducing defect constraints into the rendering filter design process is that the filters, which are normally shift invariant on panels with no defects, become shift-varying when one or more defect constrains are introduced. This is a consequence of the defects not being regularly tessellated on the display as in the sub-pixel pattern of the macro-pixels.

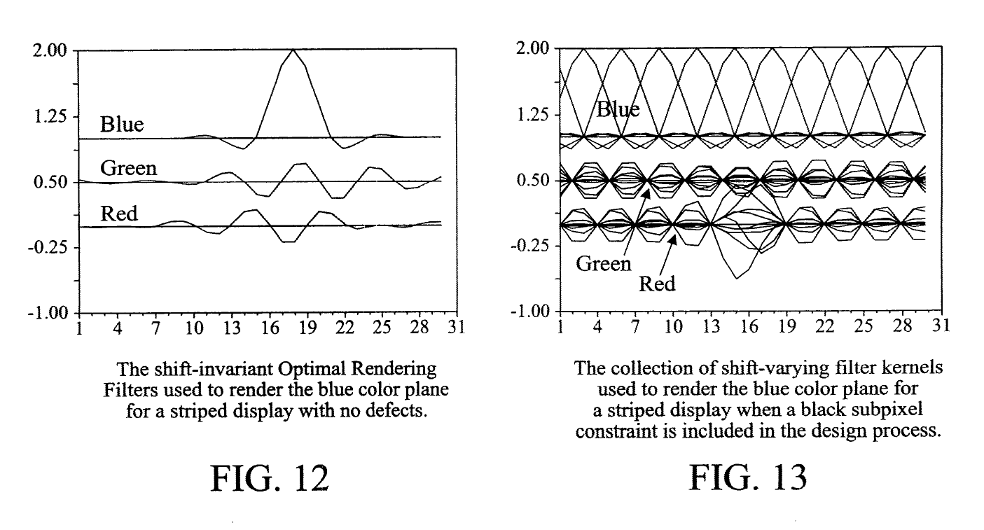

The plots of FIG. 12 show an example of optimal rendering filters for the blue color plane of a one-dimensional striped display that is without defects. The three graphs correspond to three of the nine scalar filters in the matrix rendering filter of equation 6. Shown from bottom is top in the figure to the bottom row, [h_{r→b}, h_{g→b}, h_{b→b}], of filters in the matrix that render the blue color plane. The three shift-invariant filters are shown at one position along a scan line (center tap over sub-pixel number 18) as they are convolved with their respective input data. As these filters participate in the rendering operation, their shape remains fixed so one need only show them for one position along a scan line.

On the other hand, when rendering onto a panel with blue sub-pixel defect at sub-pixel number 18, the shapes of these filters vary considerably in the vicinity of the defective sub-pixel, as shown for the different positions of the filter kernels shown in FIG. 13.

It is noteworthy that the kernel whose position corresponds to shift position 18 is identically zero. This is expected because the technique has set the blue output to zero at this point. Another observation is that as the defect masking filters move away from the defect, they converge to the shape of the invariant rendering filters. The implication is that the rendering filters and the masking filters can be combined to operate in a seamless way along the scan line without any ‘boundary transition’ artifacts.

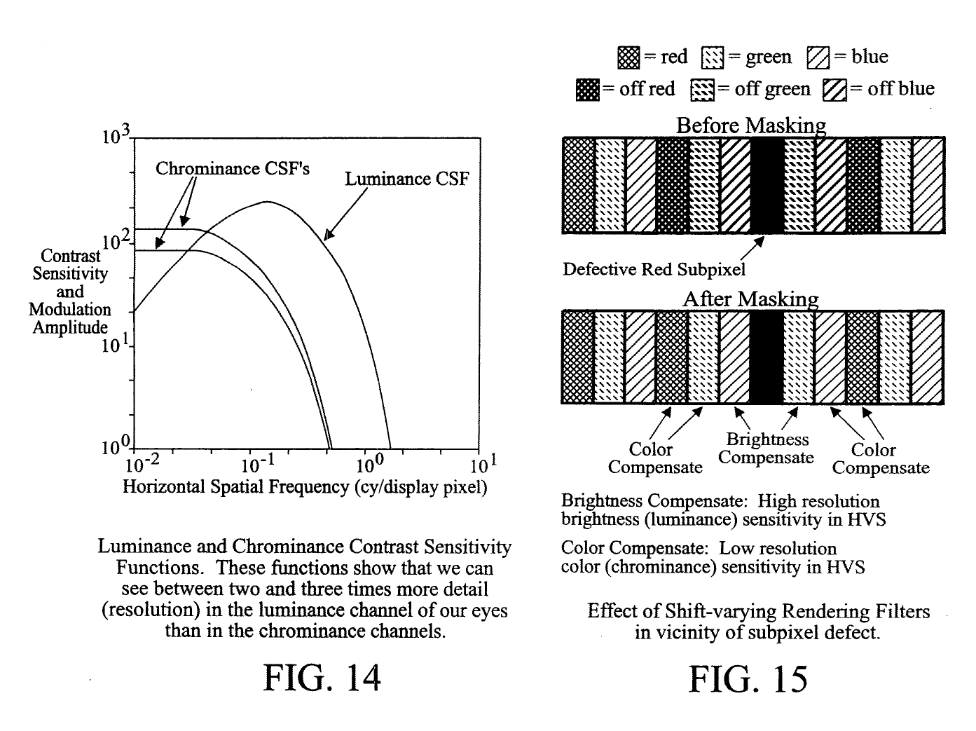

The shift varying nature of the defect masking filters gives them a certain intelligence as they render the sub-pixels in the vicinity of a defect so as to mask its visibility from the viewer who is looking at the panel from a normal viewing distance. This intelligence derives from the fact that the weighting functions used in the rendering filter design process are preferably based on the CSFs of the human visual system and therefore have contained within them the relative sensitivity of the HVS to grey scale and color detail. This is shown by the theoretical luminance and chrominance CSF curves plotted in FIG. 14.

The behavior of the rendering filters is depicted in FIG. 15. In masking the effects of a defect on luminance and color, the sub-pixels that are nearest the defect are automatically used to compensate for the luminance error because, otherwise, the viewer would see the masking as an artifact. On the other hand, the viewer's relative insensitivity to color detail allows the rendering filters to modulate the color of the sub-pixels further away from the defect to compensate for the color error introduced jointly from the defect and from the effect of the luminance compensation.

The defect masking described above may be used during the manufacturing process or subsequent to purchase by the user to decrease the visual effects of defects. It is desirable to include features in the display so that the user may even more readily decrease the effects (or otherwise mask) of defects located by a consumer after purchase. These defects may be located automatically by the system or otherwise located with interaction by the user. Once the location and type of defect is determined by the system, the defect is masked, thus hiding its presence and reducing its annoyance.

Several components may be used to facilitate the creation of a defect masking system which can be updated following manufacture. Some of the components include: (1) defect list consisting of anticipated display defect positions and types, (2) defect masking filter(s) for each anticipated type of defect, (3) defect masking processor for applying the appropriate filters, and (4) a mechanism of determining defect type and location via user feedback based upon test patterns produced by the display. The system may modify its list by removing or adding additional defects and their corresponding masking filters. The defect masking processor selects the appropriate masking filters from the stored set of filters. Defect masking uses a set of filters to modify sub-pixel values in a neighborhood of the defect. An updatable set of defect masking filters is designed offline for each expected defect type and provided with the display. Defect masking is accomplished using a list of known defects which specifies for each defect the location, color, and type of the defect. During operation, a processor applies defect masking filters in a neighborhood of each member of the list to reduce the visibility of the defect.

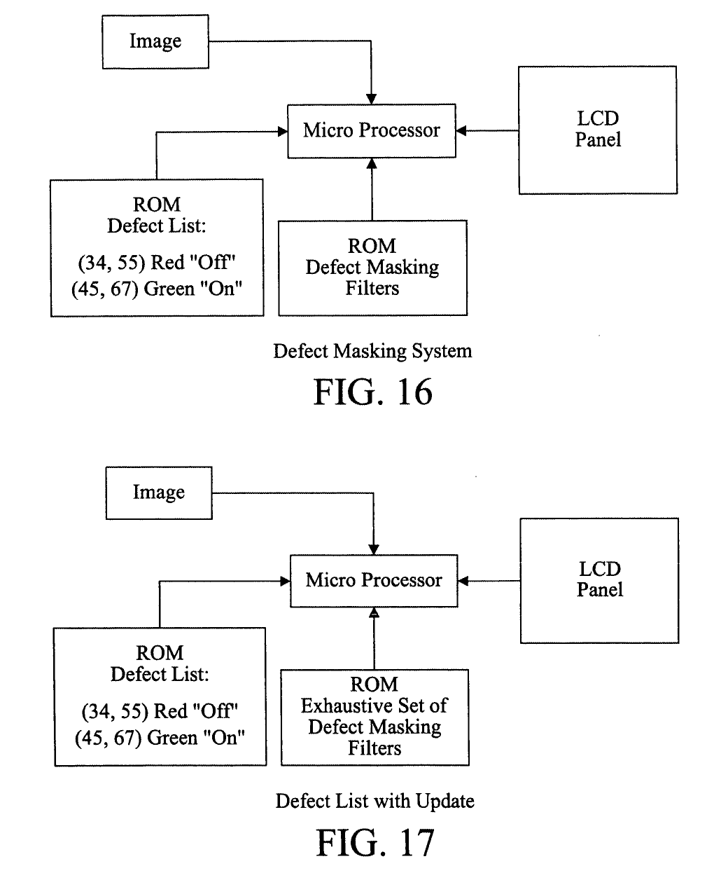

A block diagram illustrating the basic defect masking system is shown in FIG. 16. During operation a microprocessor reads the defect list and for each defect selects an appropriate set of defect masking filters based on the defect color and type. The filters are applied to the image data in a neighborhood of the defect. The resulting data is sent to the LCD panel. Preferably both the defect masking filters and defect list are stored in the display prior to providing the display to the user. In order to minimize the amount of storage required the manufacturer may simply store the defects and corresponding masking filters found during manufacturing inspection for that particular display.

Another masking system is illustrated in FIG. 17. A more exhaustive set of defect masking filters are preferably stored in each display, including defect masking filters for defects that were not found during manufacturing inspection for that particular display. In addition, filters may be provided for all defect colors and types i.e. red, green, and blue and “On” and “Off”. This requires additional memory for defects that do not currently exist in the particular display, but it provides the ability to mask additional defects that may occur during the life of the display. By way of example, the supplied list of defects may be initially populated with defects found during manufacturing inspection, if any. Additionally, a mode of operation may be provided where additional defects may be added to the list (such as through a network, an Internet connection, and/or download directly to the device through a memory storage device) thus masking additional defects that are discovered by the user and/or “after purchase”. Two principal techniques may be used to include additional defects to the list, namely, (1) automatically and/or (2) via user interaction. In the automatic technique, circuitry on the panel monitors and detects defects. Detected defects are be added to the list of defects enabling self diagnosis and repair.

The use of user interaction to assist in updating the defect list is discussed in greater detail below. Briefly, the system will enter a mode where defects can be added. The microprocessor generates test patterns to guide the user and prompt user's responses to simple questions. Based upon the user's response to questions the system determines the color and type of defect. The location of the defect is determined by having the user place an indicator (overlaid on the displayed test pattern) over the observed defect. The test patterns are designed to facilitate user-friendly classification and location of defects as well as to indicate those defects already present in the system.

The defect list contains a detailed description of defects on the panel. This defect list is used to control the defect masking operation by primarily selecting the defect masking filters to apply and where to apply them in the image. An example defect list is in Table 1. Note the defects are ordered in raster scan order for convenience.

TABLE 1
Sample Defect List

| Row | Column | Color | Type |
|---|---|---|---|
| 33 | 57 | Red | On |
| 122 | 282 | Green | Off |
| . . . | . . . | . . . | . . . |

Defect hiding may consist of selecting for each defect a set of one or more defect masking filters based on the defect color and type and, modifying the image values in a neighborhood determined by the row and column of the defect. The ability to update the defect list allows the system to mask defects found after manufacturing or sale.

The defect list can be populated and/or modified in several different ways, three of which are described herein, namely, (1) during inspection, (2) automatically (during operation), and (3) by user interaction. During manufacturing an inspection is conducted which can determine the location, color, and type of each defect. Such inspection may be part of the manufacturing process. Information about the defects is used to initially populate the defect list. The ability to automatically detect defects relies upon additional circuitry built into the panel. During manufacturing this additional circuitry can be used in place of the inspection process with the results stored into the defect list. A panel equipped with this additional circuitry can also scan itself after the panel is sold and thereafter adding the results to the defect list (and potentially obtaining any additional filters, as needed). This scan could be conducted during power on or periodically. User feedback may be used to modify the defect list allowing defect masking following sale.

The interactive mode may be entered by a user or repair technician when a defect is observed. User interaction is used to supply the location, color and type of a panel defect. This information is then placed into the defect list for subsequent masking. A user based system may use an interactive diagnosis mode for determining the information about defects. In this interactive diagnosis mode, the system provides test targets and queries to the user to determine the color and type of defect. The user then specifies the position using an interactive on-screen locator such as movable cross-hairs driven from, for example, the “arrow-key” thumb pad on the remote control. The test patterns selected preferably tend to enhance the visibility of defects and facilitate determining their color and type. Additionally, defects already known to the system may be indicated.

The preferred procedure is to generate test patterns for different colors and types of defects, once the display system is switched to an interactive diagnosis mode. Following each image the user is prompted if any defects are visible. An affirmative answer is followed by the user specifying the coordinates of the defect using an appropriate interactive mechanism and typically involving the remote control of the display device, and LCD TV, to facilitate convenient user interaction. The defect is then added to the defect list.

Different test patterns can be used with this technique. The system should be able to ascertain the type and color of a defect based on presenting images to the user and responses to simple questions. Four test patterns may be used where each test pattern is designed to enhance the visibility of particular defect(s). (For the sake of convenience to the user in locating the new defects, the a priori known defects may be surrounded by a square or other distinguishing feature. The example below will illustrate this aspect.) The test pattern is designed to determine the defect type and color, the color will be asked for Always On defects. Defects known to the system are indicated in the test image. Test images with empty defect list and defect free display are shown below:

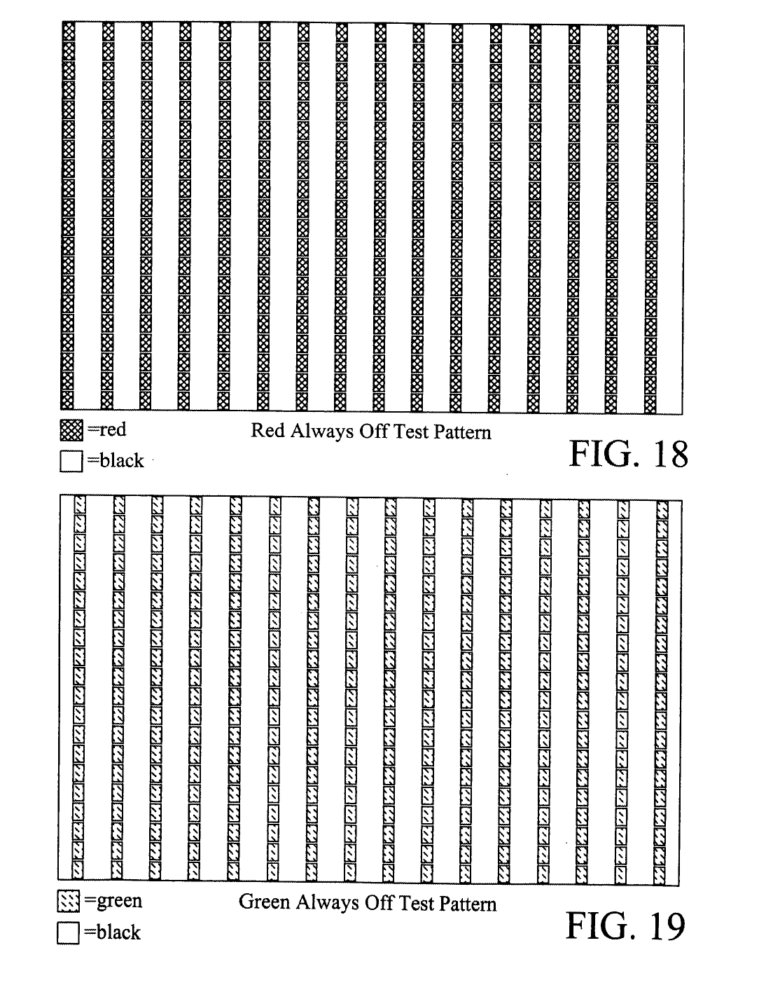

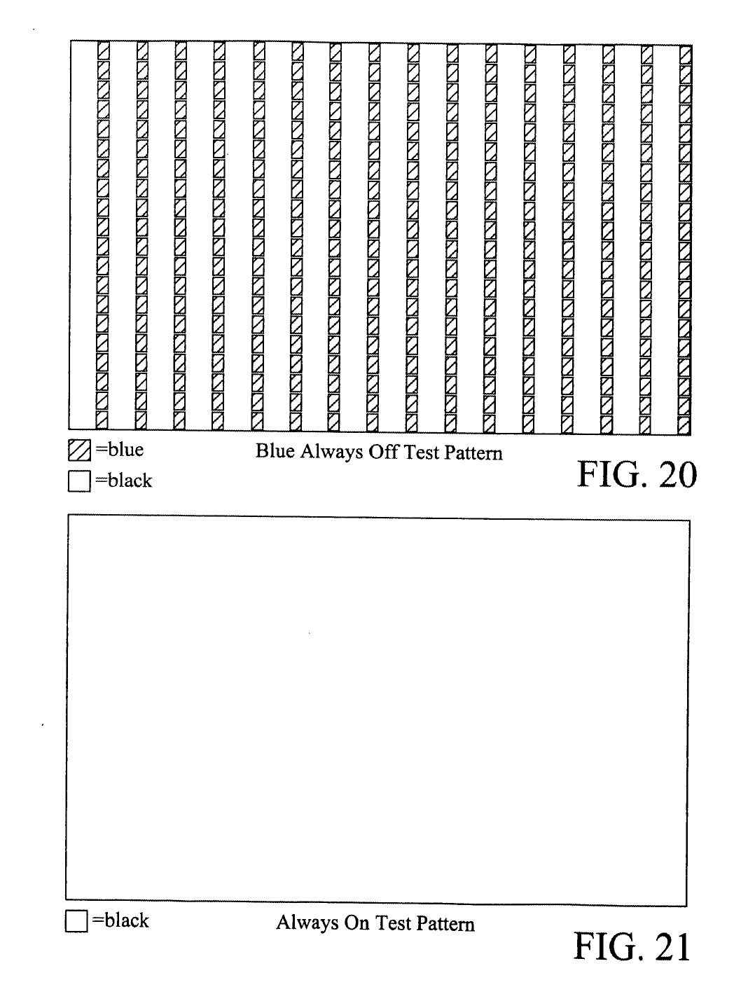

In the discussion below, six test patterns are shown one for each defect type, always on/always off, and defect color, red, green, or blue, combination. Each test pattern is designed to enhance the visibility of a particular class of defect(s). (For the sake of convenience to the user in locating the new defects, the a priori known defects may be surrounded by a square or other distinguishing feature. The example below will illustrate this aspect.) The test pattern is designed to determine the defect type and color, the color will be asked for when evaluating always on defects. Sample test patterns generated for by the system when the defect list is empty and seen on a defect free display are depicted below in FIGS. 18, 19, 20, and 21. FIG. 18 illustrates red always off test pattern, FIG. 19 illustrates green always off test pattern, FIG. 20 illustrates blue always off test pattern, and FIG. 21 illustrates always on test pattern.

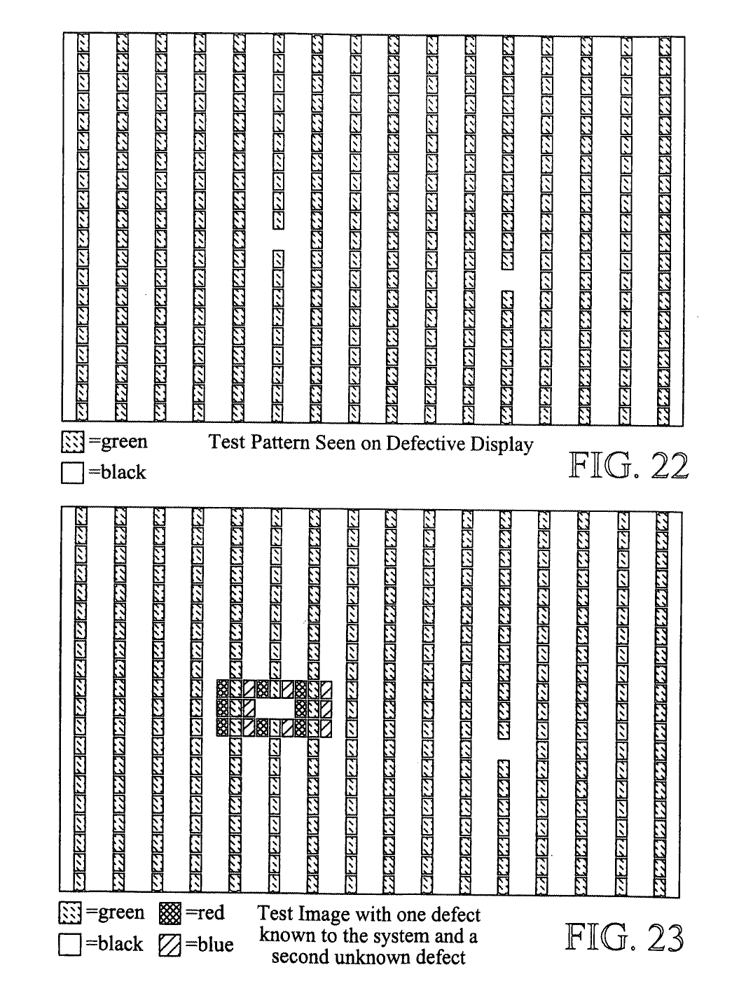

Next is illustrated a sequence of images scene by the user when the test patterns of FIGS. 18-21 are used on a display with defects and the user interaction identifies the defects. For the first example one assumes the display has two always off green defects neither of which are known to the system. No defects are seen when displaying the red always off, blue always off, or always on test patterns. When the green always off test pattern is shown on the display, the user sees the image depicted in FIG. 22. (Note the two green defects visible)

After seeing this test pattern the user is asked: “Did you see any black spots in the regular pattern of green lines unknown to the system?” An affirmative response in this example activates a control allowing the user to navigate to the position of the defect and select it. Once selected, the coordinates of the defect are added to the defect list, as a green always-off defect in this case. The test pattern is modified by surrounding the known defect with a white square, or other distinguishing feature, and the user is again asked if any defects are seen. The image of the modified test pattern seen by the user is depicted in FIG. 23.

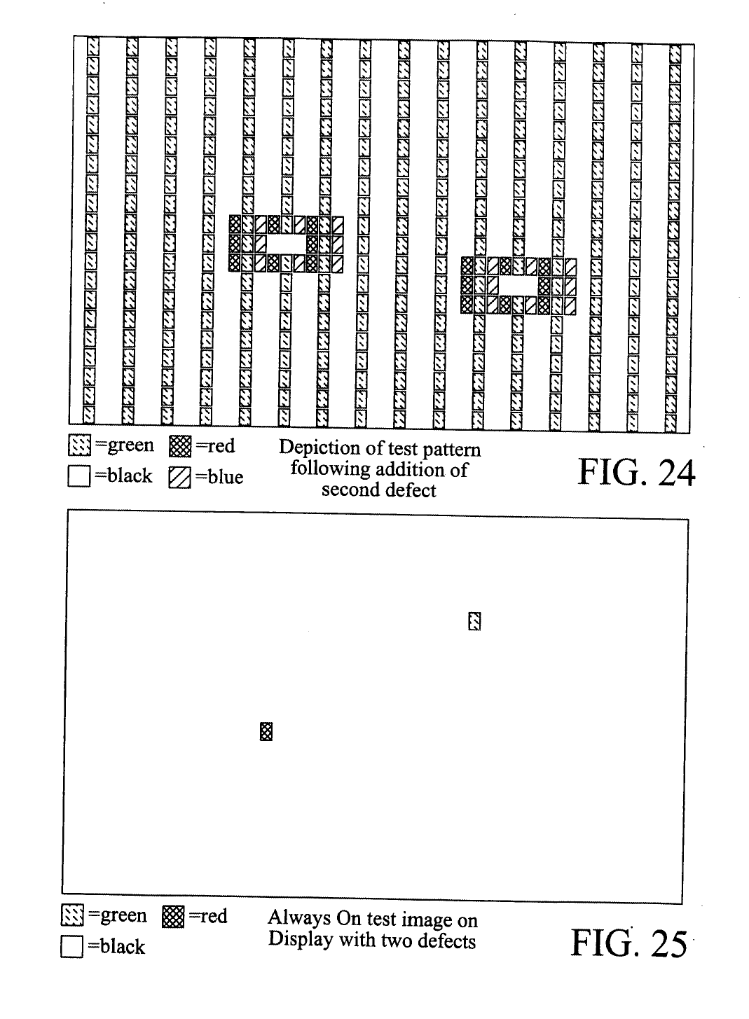

A second defect is unknown to the system and appears as a black spot in the regular pattern of green lines. After seeing this test image the user is asked: “Did you see any black spots unknown to the system in the regular pattern of green lines?” An affirmative response activates a control allowing the user to navigate to the position of the defect and select it. Once selected, the coordinates of the defect are added to the defect list, as a green always off defect in this case. This additional defect is added to the defect list. It is surrounded with a white square in the test pattern and the user is again asked if any defects are seen (see FIG. 24).

The red and blue always off defects are treated similarly. The always on defects are addressed slightly differently. A single test image is used for all colors and the user is asked for the color of the defect seen.

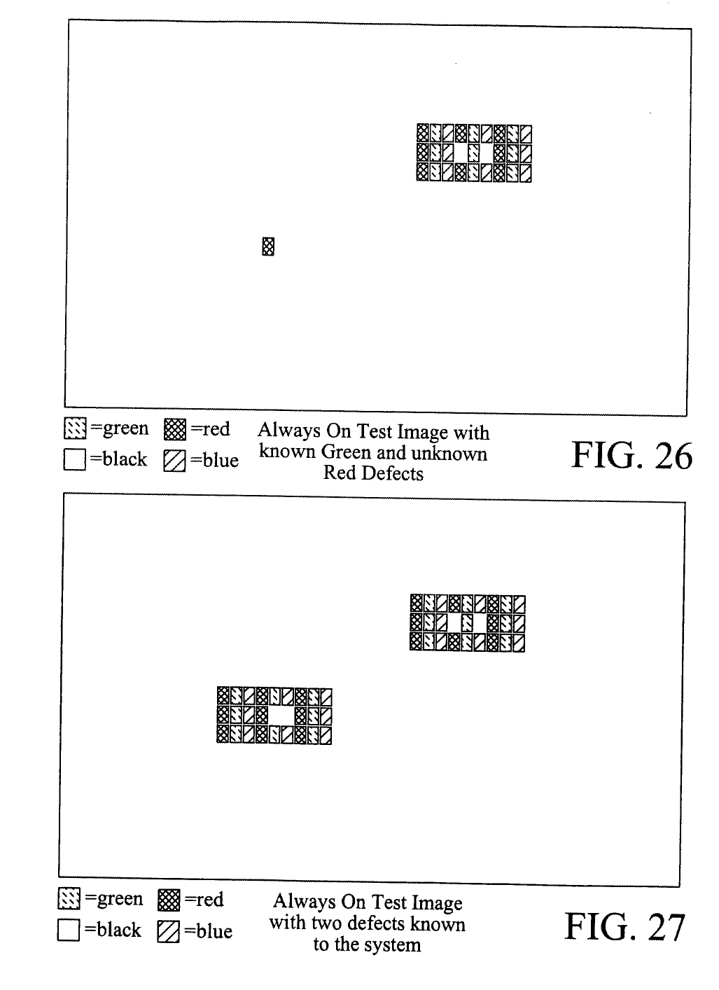

The user's view of the always on test image on a display with two always on defects is shown in FIG. 25. The user is asked: “Do you see any defects unknown to the system?” An affirmative answer prompts an additional: “Select the defect color”. After the user selects Green, the user is asked to locate the defect. The defect is entered in the defect as an always on defect with location and color supplied by the user. The test image following entering the green defect is shown in FIG. 26.

The process is repeated and the red defect is entered into the system. The resulting test image is shown in FIG. 27.

Some of the techniques discussed herein are for discovering the position, color, and type of all pixel defects after the display panel has been sold to the customer, so that those defects not already known to the panel firmware can be entered and masked. However, the actual procedures for use described or implied herein are also appropriate for a repair technician (or savvy user). For example, it is comparatively difficult on a 45″ display to visually find a single “always off” sub-pixel defect whose location is not known beforehand using the patterns, especially if the color of the defect is also not known beforehand. Hence one may also consider modification to the suggested or implied usage described above. The following scenario is merely by way of example of another embodiment.

The expected “use pattern” for a typical user might be as follows. The user, while viewing a program on television, notices, say, an “always off” green defect. He gets up and moves closer to the screen to see what the speck is, and realizes it is, in fact, a defect. Of course he has no idea what color the defect is since the average user knows nothing about subtractive color. A green defect on a white background will appear roughly red to the user.

At this point the user uses his remote control and pushes a button labeled (for example) “Correct Defects”. Up comes (say) a 256×256 full white patch on a black background together with an indication that this is steerable around the screen and a brief instruction to move the patch around so that the defect appears somewhere inside the patch. Since he will remember the approximate location of the defect he just saw, he easily steers the patch over the defect. The small size of the patch enables him to easily locate the defect once it is inside the patch. He is then asked what color the defect appears to be: reddish, light blue, or yellow. His answer indirectly gives the system the true color of the always-off defect. Finally, a steerable means of locating the defect is presented and the user locates the defect and enters it (by means of a button push) into the system.

Since locating the defect is an important aspect and tends to be an error-prone part of the procedure, the user should also be given a means of deleted a defect from the internal list or disabling the masking of a defect in case he enters the wrong position. In addition, it may be better, during location, to substitute for the white patch a 256×256 version of the patterns based on the color entered, so as to make the defect position easier to see. This would also serve to verify that the user did, indeed, pick the correct color. Various verification queries along the way should be used to keep the user from mistakes.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

I/We claim:

1. A method of adjusting an image to be displayed on a display having at least one defective sub-pixel:
(a) receiving an image;
(b) modifying said image with a filter to reduce the appearance of said at least one defective sub-pixel;
(c) displaying said image on said display;
(d) wherein at least one of said user and said display may identify said defective sub-pixel on said display which identifies a suitable said filter for said modifying.

2. The method of claim 1 wherein said modifying is based upon an optimization which reduces a perceptually relevant metric.

3. The method of claim 1 wherein based upon said identification said display obtains an additional suitable said filter not previously included with said display.

4. The method of claim 1 wherein based upon said identification wherein based upon said identification said display obtains an additional suitable said filter through the Internet.

5. The method of claim 1 wherein said filter is selected based upon the location, the color, and the type of defective sub-pixel.

6. The method of claim 1 wherein said display includes a suitable said filter for each of said at least one of defective sub-pixels identified prior to selling said display to a consumer.

7. The method of claim 1 wherein said display identifies said defective sub-pixel.

8. The method of claim 1 wherein said user identifies said defective sub-pixel.

9. The method of claim 1 wherein said user identifies said defective sub-pixel based upon at least one test pattern.

10. The method of claim 9 wherein said at least one test pattern includes a presentation of primarily red sub-pixels.

11. The method of claim 9 wherein said at least one test pattern includes a presentation of primarily blue sub-pixels.

12. The method of claim 9 wherein said at least one test pattern includes a presentation of primarily green sub-pixels.

13. The method of claim 9 wherein said at least one test pattern includes a presentation of primarily all sub-pixels.

14. The method of claim 9 wherein said at least one test pattern includes a visual indication of said defective sub-pixel.

15. The method of claim 2 wherein said filter is based upon a reduction of an error based metric.

16. The method of claim 15 wherein said filter is based upon an array of one-dimensional re-sampling filters.

17. The method of claim 16 wherein said metric models the contrast sensitivity function of the human visual system's luminance response.

18. The method of claim 17 wherein said metric models the luminance sensitivity function of the human visual system's chrominance response.

19. A method of adjusting a display comprising:
(a) providing a mode of said display for identifying a defective sub-pixel selectable by a user;
(b) generating at least one pattern on said display;
(c) said display enabling said user to identify said location of said defective sub-pixel;
(d) said display filtering said defective sub-pixel to reduce the visual effect to said user.

20. The method of claim 19 wherein said defective sub-pixel is off.

21. The method of claim 19 wherein said defective sub-pixel is on.
